(19) United States
(12) Patent Application Publication
(10) Pub. No.: US 2022/0099219 A1
(43) Pub. Date: Mar. 31, 2022

(54) Pipe Supporting Device and Method of Manufacture Thereof

(71) Applicant: James M. Brown, Richland Hills, TX (US)

(72) Inventor: James M. Brown, Richland Hills, TX (US)

(21) Appl. No.: 17/038,029

(22) Filed: Sep. 30, 2020

(51) Int. Cl. F16L 3/10; B29C 43/00

(52) U.S. Cl. CPC F16L 3/1058; B29K 2105/26; B29C 43/003

(57) ABSTRACT

A pipe supporting device is used to support an exposed pipe on a roof. The device includes a base which is formed of a crumb rubber waste product having a flat bottom for resting on the roof, an upright member of a length which is connectable to the base and a pipe receiving portion which is connectable to the upright member for receiving and supporting the exposed pipe. The length of the upright member can be altered by a user at a job site to thereby provide a device having a desired overall height. The crumb rubber base forms a mat surface which is of sufficient area to support the upright components of the device without requiring that the base be glued to the roof surface.

### BACKGROUND OF THE INVENTION

### 1. Field of the Invention

The present invention relates generally to improvements in support arrangements for exposed pipes and conduits and more specifically, to a support system for an exposed pipe or conduit on the roof of a building, in an attic or mechanical room, or the like, such as, for example, the condensate drain line of an air conditioning unit or an electrical conduit located on the roof of a building.

### 2. Description of the Prior Art

A variety of devices have been used in the prior art in order to support exposed pipe. Support devices are necessary for a number of reasons, such as to prevent undue strain being placed upon a pipe or coupling. In some cases, it is necessary to support the pipe at a slope with respect to an adjacent support area, such as in the case of condensate drain lines from air conditioning/heating systems, or in the case of sewer pipes and lines.

Commercial buildings often have various types of pipes which are exposed and run along the rooftops of such buildings. For example, it is quite common for air conditioning units to be mounted on a building roof of a commercial building, the air conditioning units having condensate drain pipes which slope from the unit toward an exit point on the rooftop. Other service units are commonly mounted on building roofs which utilize pipes which must be supported, often at a slope with respect to the surrounding rooftop. Modern building code requirements also dictate that pipes be properly supported in attics, mechanical rooms, and the like, in many situations. Electrical conduit must also be supported and mechanically attached on building roofs.

In the past, it was common practice for mechanical and heating/ventilation contractors and roofers to hand saw pieces of wood of the desired height to support air conditioner condensate drain pipes. This procedure is time consuming and labor intensive. While various devices are shown in the prior art of this type, one example is U.S. Pat. No. 4,513,934, to Pruyne, issued Apr. 30, 1985. This patent shows a pipe supporting device adapted to receive and support an exposed pipe on a building roof. The device has a base with a substantially flat bottom for resting on the roof and an upwardly tapered structure secured on and rising from the base to provide upwardly divergent, V-shaped recesses for receiving the pipe and supporting it above the base. One problem with the device shown in the '934 patent is that the upright portion of the device is not adjustable in length. As a result, it is not possible to vary the overall height of the device except by stacking multiple devices, one upon the other, thereby adding to the cost of the installation. Of course individual devices of the type shown in the '934 patent could be manufactured of different overall heights, however this would lead to additional expense in manufacture and require that the user maintain an inventory of different height devices in order to provide the slope required at the particular job site. It was realized that an adjustable, ready-made device would save time and money.

Applicant's prior U.S. Pat. No. 5,906,341, to James M. Brown, issued May 25, 1999 and U.S. Pat. No. 6,076,778, to James M. Brown, issued Jun. 20, 2000, solved certain of the noted deficiencies of the prior art with respect to pipe supporting devices then available in the marketplace. The Pipe Prop® solved the problem of providing an adjustable height for the support by providing an upright member which could be altered by a user at a job site to thereby provide a device having a desired overall height for supporting an exposed pipe. The Pipe Prop® is made of a tough, durable synthetic plastic that is made to withstand severe weather conditions without buckling, shattering or otherwise deteriorating even in heavy rain, wind, sunlight or hail. The Pipe Prop® product has gained the official Miami-Dade Notice of Acceptance for use in all areas of Florida. The Pipe Prop® is commercially available from Pipe Prop, LLC, 6340 Baker Boulevard, Fort Worth, Tex. 76118.

In order to meet the requirements of certain extreme environmental or weather conditions, and the like, a more specialized version of the original Pipe Prop® was developed. For example, certain areas of the country have specialized building codes for hurricane and tornado prone zones. Applicant's issued U.S. Pat. No. 9,523,380, issued Dec. 20, 2016, to James M. Brown, describes a modified Pipe Prop® type product which uses an upright steel reinforcing component within the upright of the device to provide additional structural support for the pipe supporting devices in extreme environments, such as hurricane zones.

Despite the many advances made in the Pipe Prop® product line over the years, some customers have particular needs which need to be addressed. For example, some have requested a version of the product which would not require the use of an adhesive to glue the base of the product to a rooftop, as in a commercial air conditioning installation.

Accordingly, the present invention has as its general object to provide a pipe supporting device which is simple in design and economical to manufacture and which can support all exposed pipe at a desired slope with respect to a surrounding support surface, such as a building roof, without the use of a glue or adhesive to assist in holding the Pipe Prop® in place during the installation process and thereafter.

Another object of the invention is to provide such a pipe supporting device of standard components which can be mass produced at an economical price but which features a base component which is stable enough to support the upright components of the device, without requiring the application of an adhesive to the base.

### SUMMARY OF THE INVENTION

The pipe supporting device of the invention is adapted to receive and support an exposed pipe, as on the rooftop of a building. The device includes a base having a flat bottom for resting on an associated support surface, such as the roof. An upright member of a first selected length is connectable to the base. A receiving portion, connectable to the upright member receives and supports the exposed pipe. The first selected length of the upright member can be altered by a user at the job site to thereby provide a device having a desired overall height for supporting an exposed pipe.

A pipe supporting device is also shown which is adapted to receive and support an exposed condensate drain pipe from an air conditioning unit located on a rooftop. The device includes a base having a flat bottom for resting on the roof and having an upwardly extending receptacle portion. An upright member of a first selected length has a first extent which is insertable within the upwardly extending receptacle portion of the base. A saddle shaped receiving portion is also provided for receiving and supporting the exposed pipe. The saddle shaped receiving portion has a downwardly extending receptacle portion for receiving an opposite extent of the upright member. The first selected length of the upright member can be altered by a user at a job site to thereby provide a device having a desired overall height for supporting an exposed pipe at the desired height on a roof. Preferably, the upright member is a length of PVC pipe which has graduations provided along the length thereof. The first selected length of the upright member is altered by severing the length thereof at a selected graduation. Engagement members can also be provided which are connectable with the saddle shaped receiving portion for engaging and securing a portion of a pipe which is received and supported within the saddle shaped receiving portion.

The preferred pipe supporting devices of the invention have a base which is formed of crumb rubber waste product. The base takes the form of a pad or mat in its finished state. The base has a top surface and a flat bottom surface for resting on the roof, and wherein the upwardly extending receptacle portion which is formed in the top surface of the base comprises a hollow length of synthetic plastic material which is seated within an opening in the top surface of the mat and which is selectively sized to receive the opposite extort of the first upright member and snugly engaging the upright member. The first upright member and the receptacle can both be formed of a length of PVC pipe.

A method is also shown for supporting an exposed conduit on a surrounding support surface. A plurality of conduit supporting devices are provided beneath the conduit at spaced intervals along the conduit on the surrounding support surface. Each of the conduit supporting devices has a base with a flat bottom for resting on the support surface and which supports additional synthetic plastic components. The base has the same upwardly extending receptacle portion and upright member as previously described.

The base of each of the conduit supporting devices is formed of The molded crumb rubber base has a top surface and a relatively flat bottom surface for resting on the roof. The crumb rubber base is manufactured by the following steps:

a quantity of raw crumb rubber pellets are first poured into a mold, the mold being divided into a plurality of cavities, each having a bottom surface, surrounding sidewalls and an initially open top, each of the cavities also having an upright solid plug approximately centered in the cavity on the bottom surfaces thereof;

in the next step of the process, a hydraulic press is lowered over the mold so that the press comes down and compresses the crumb rubber pellets in the cavities, which action causes the raw crumb rubber pellets to be heated and causes the pellets to fuse (stick) together to form a mat-like rubber product;

each mat is then pulled out of the mold, whereby the upright plug located in each cavity leaves a centrally located hole in each mat;

a PVC receptacle piece is then installed within the respective mat holes by pushing the receptacle piece into the holes, the respective receptacle pieces forming the base receptacle for the upright PVC portions of the device.

The device is then assembled by installing the upright in the base receptacle and by installing the saddle shaped receiving portion on the upright.

Additional objects, features and advantages will be apparent in the written description which follows.

### BRIEF DESCRIPTION OF THE DRAWINGS

FIG. 1 is a perspective view, partly broken away, showing an air conditioning unit on a building roof, the unit having a condensate drain pipe which is supported by a prior art Pipe Prop® pipe supporting device of the type commercially available in the marketplace;

FIG. 2 is an isolated, close-up perspective view of one of the pipe supporting devices of the invention, showing the crumb rubber base and showing a pipe being supported thereby, the pipe being shown in phantom lines;

FIG. 3 is an isolated, exploded view of the pipe supporting device of FIG. 2 showing the component parts thereof;

FIG. 4A is a simplified perspective view of the first step used in the manufacturing process used to produce the crumb rubber mat which forms the base of the pipe supporting device of the invention, in which a mold is provided with a plurality of cavities for receiving a quantity of raw crumb rubber pellets;

FIG. 4B shows the next step in the manufacturing method in which the mold top is lowered to compress and heat the crumb rubber pellets, thereby forming a plurality of cured mats within the respective mold cavities;

FIG. 4C shows the molded mat having been pulled from the mold cavity and showing the hole in the center of the mat which is left by the steel forming plug of the mold;

FIG. 4D shows the adhesive being applied to the inner sidewalls of the hole in the crumb rubber mat;

FIG. 4E shows the PVC receptacle member inserted within the hole in the crumb rubber mat;

FIG. 4F shows the completed assembly with the crumb rubber mat supporting the upright elements of the device.

### DETAILED DESCRIPTION OF THE INVENTION

The preferred version of the invention presented in the following written description and the various features and advantageous details thereof are explained more fully with reference to the non-limiting examples included in the accompanying drawings and as detailed in the description which follows. Descriptions of well-known components and processes and manufacturing techniques are omitted so as to not unnecessarily obscure the principle features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

While the invention will be described primarily in the discussion which follows with respect to roof mounted installations, it will be understood that the devices of the invention could also be used in ground locations, in attics, and other conventional locations where a need exists for pipe support. The roof installations illustrated are particularly well suited for use with the devices of the invention because of the relatively light weight and yet stable construction of the devices. Also, while the following description of the preferred form of the invention uses the term “pipe supporting devices”, it will be understood that, in some circumstances “conduit” such as electrical conduit, or other elongate materials might be supported by the devices of the invention, as well. Thus, the terms “conduit” and “pipe” are used interchangeably in the discussion which follows.

Thus, a variety of situations exist in which it is desirable to support an exposed pipe by means of a pipe supporting device. One such common situation occurs in commercial buildings which commonly have a number of exposed pipes which are supported above the roof of the building.

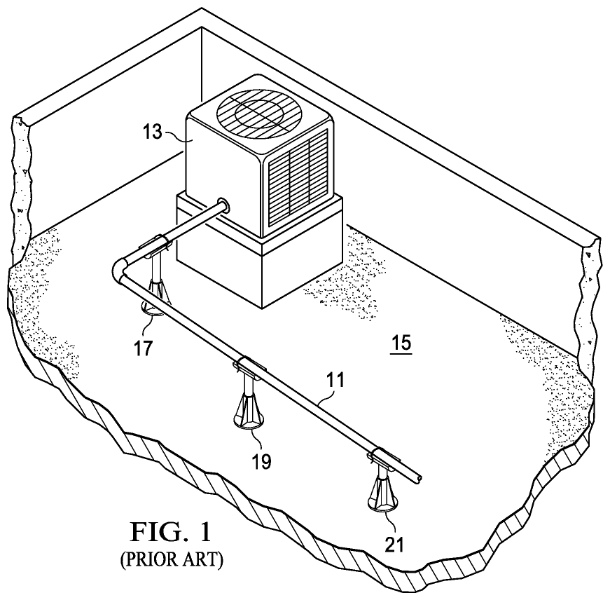

FIG. 1 shows a typical prior art installation in which a pipe 11 from an air conditioning unit 13, mounted on a roof 15, extends across the roof to a desired location (not shown) where it exits over the side of the roof, through the roof, or is connected to other roof-mounted equipment.

The prior art Pipe Prop® devices 17 are positioned on the roof 15 to support the pipe 11 as it extends along the roof. The number of supporting devices needed will depend upon the type of the pipe supported, its size, weight, overall dimensions, and the material from which it is made, as well as the particular layout employed on the roof. In general, for air conditioning systems of the type shown, it will be desirable to support the pipe with a gradual slope from the air conditioning unit in the direction of the point at which the pipe extends over the side of the roof or otherwise exits the rooftop. Thus, in the prior art installation shown in FIG. 1, the overall height of the pipe supporting device 17 is greater than that of pipe supporting device 19 which, in turn, is greater than the overall height of pipe supporting device 21.

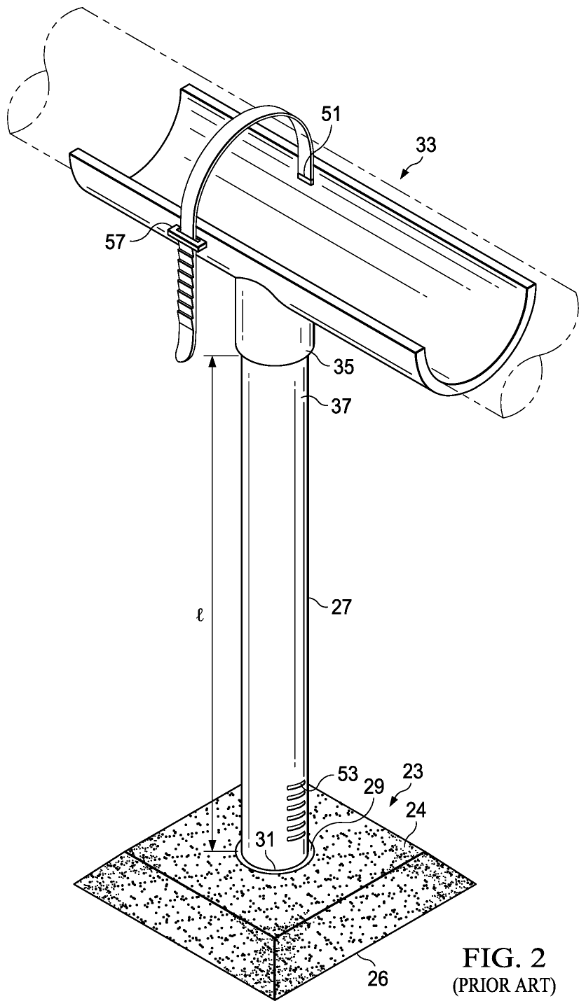

FIG. 2 is a close up, perspective view of one of the improved Pipe Prop® devices of the invention. As can be seen in FIG. 2, the pipe supporting device of the invention includes a base 23 having the general shape of a trapezoid when viewed from the side, i.e., a flat shape with four straight sides that has a pair of opposite sides parallel and two sides non-parallel. In this case, the top side 24 and the bottom side 26 are parallel, as viewed from the side. The bottom side 26 allows the device to rest stably on a roof such as the roof 15 in FIG. 1, or other surrounding area. An upright member 27 of a first selected length (“l” in FIG. 2) is connectable to the base 23.

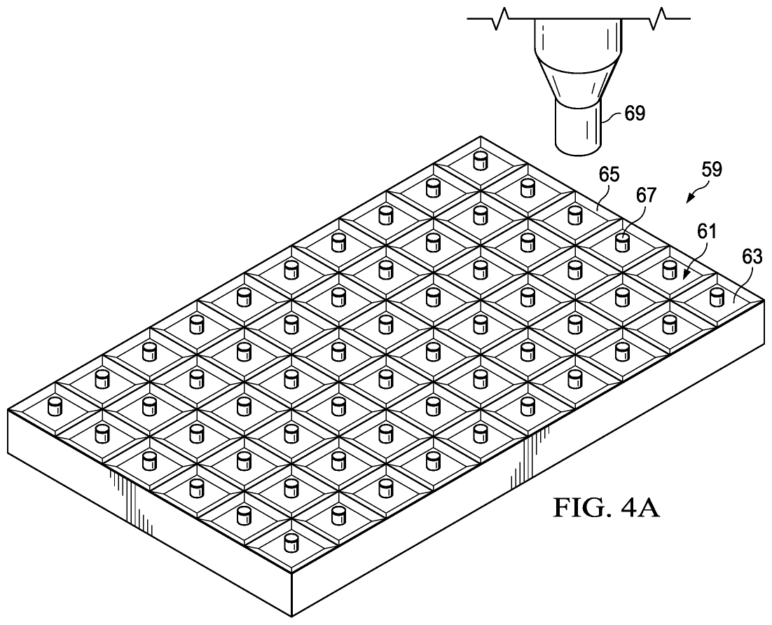

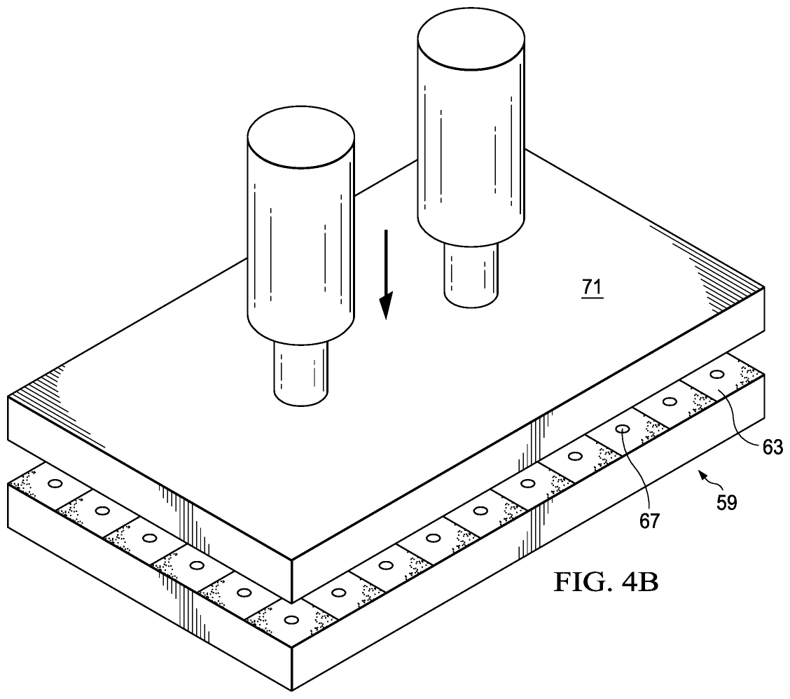

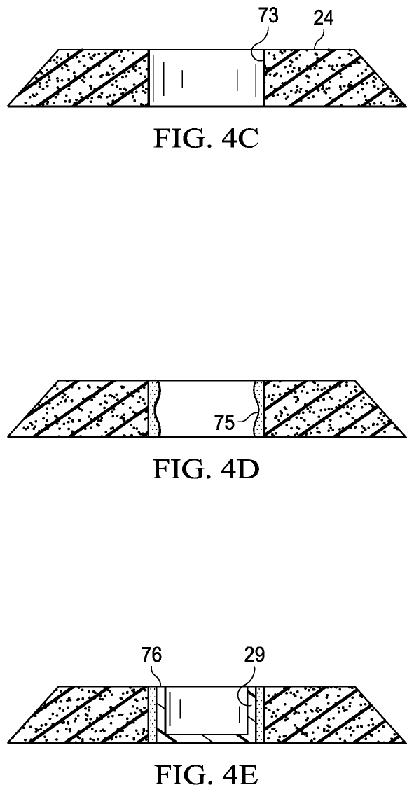

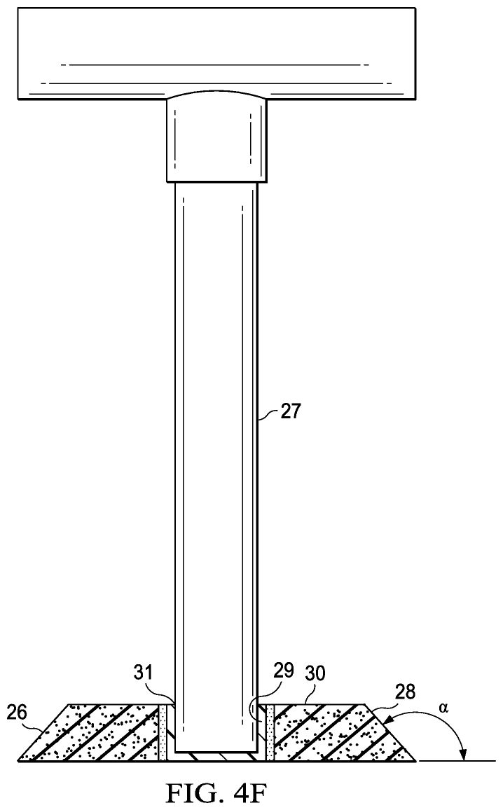

As will also be apparent from FIGS. 2 and 4F, the new base has been designed with an intentional aerodynamic nature, i.e., it is tapered for wind velocity. Note in FIG. 4F, how the sides 26, 28 slant at an approximate 45° angle, designated as “α” in FIG. 4F. The flat top surface 30, together with the tapered sides 26, 28, and the round shape of the upright piece 27 all act to cut down on wind resistance which can be important in windy conditions. In wind velocity tests, a square base member was picked up by the wind, whereas the tapered base of the invention stayed in place. The wind current does not tend to slip stream over the new mat design.

The exact size of the base of the mat 23 will depend, in part, upon the nature of the installation at hand. It is only necessary that the base has a bottom surface area sufficient to stably support the pipe or other conduit. In one example, the bottom area of the base is approximately 8 inches by 8 inches in size and is suitable for supporting the typical air conditioner drain pipe installation, such as the installation shown in FIG. 1.

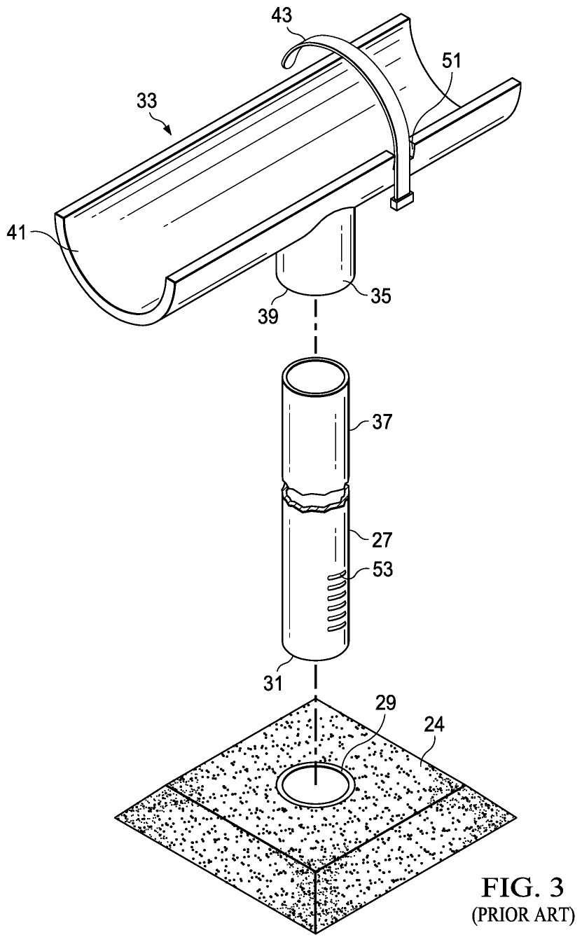

As can be seen in more detail in FIGS. 3 and 4E-4F, the base has an upwardly extending receptacle portion 29. The upright member 27, formed of a synthetic plastic material of a first selected length, has a first extent 31 which is insertable within the upwardly extending receptacle portion 29 of the base 24 to engage the base receptacle portion. A pipe receiving portion 33 is connectable to the upright member 27 and is adapted to receive and support the exposed pipe 11 (FIG. 1). The upright 27, as well as the receiving portion 33, can be conveniently injection molded of a suitable plastic material, such as polyvinylchloride plastic (PVC) or a suitable polyolefin material.

The upright member 27 is conveniently provided as a length of PVC pipe which is commercially available from a number of sources. The upright member 27 shown in FIGS. 1 and 3 is a length of ¾ inch I.D. PVC where the pipe supporting device is intended to support the condensate drain pipe of an air conditioning unit mounted on a roof.

As shown in FIG. 3, the saddle shaped receiving portion 33 has a downwardly extending connector portion 35 which is connectable with the opposite extent 37 of the upright member 27 to complete the assembly. As best seen in FIG. 3, the downwardly extending connector portion 35 is a cylindrical member having an end opening 39 which is similar to end opening of the receptacle 29 in the base 24 for receiving and securely engaging the upright member 27. The receiving portion 33 also has a concave receiving recess 41 for receiving the pipe 11 to be supported. The concave recess 41 is available in sizes ranging from about ½ inch I.D. to a maximum of 1½ inch I.D. for supporting the drain pipes of air conditioning units.

An engagement member, such as the tie wrap 43 is connectable with the saddle shaped receiving portion 33, as by a slot, 51, provided therein, whereby a pipe which is received and supported within the receiving recess 47 can be securely engaged within the receiving portion. The tie wrap passes about the exterior of the pipe and saddle shaped receiving portion and is held in place by the slot 51 and opening 57, best seen in FIG. 2.

The first selected length of the upright member 27 can be altered by a user at the job site to thereby provide a pipe supporting device having a desired overall height for supporting the exposed pipe 11 at a desired height on the roof. Preferably, the upright member 27 is provided with graduations 53 (FIG. 3) along the length thereof and is alterable by severing the length thereof at a selected graduation. In the case of a PVC pipe, this can be conveniently accomplished by sawing the member with a saw, cutting the member with a cutting tool or by breaking the member at a frangible region provided therein. By whatever means, it is only necessary that the user be able to alter the overall length of the upright member 27 at the job site in order to provide a pipe supporting device of a desired overall height to fit the intended location of use. In the case of the air conditioner 13 shown in FIG. 1, the condensate drain line 11 is provided with a gradual downward slope as it exits the air conditioner by supplying pipe supporting devices of gradually diminishing height so that condensate easily drains from the air conditioner to a drain point on the roof.

As has been mentioned, the base 24 of the device is preferably formed of waste crumb rubber. “Crumb rubber” is commonly known in the relevant industries. A chief source of crumb rubber is discarded vehicle tires. The Rubber Manufacturers Association reports that over two billion used tires have already been discarded in the United States and that the number discarded each year is on the order of 250 million. Uncontrolled incineration is not an acceptable means of disposal of tire rubber, and burial in landfills is increasingly difficult as the availability of landfills diminishes.

To avoid the problems of disposal, various means have been developed to extract usable rubber from used tires. Reclamation processes generally begin with the comminution of the tire material into one-inch to two-inch tire chips, which are then used as an energy source in the generation of electricity and the production of paper and, cement. Other processes grind the tire chips to micron sizes, termed “crumb rubber.” Crumb rubber is mixed with various polyurethanes, surface modifiers, polymers derived from maleic anhydride, or combinations of these additives in the manufacture of roofing materials, walk pads, carpet backings and pads, and flooring underlays.

Examples of the types of fillers and resins used in preparing construction materials from crumb rubber are found in Crivelli et al., U.S. Pat. No. 5,258,222 (Nov. 2, 1993), which describes the incorporation of coarse siliceous grains and a polymerizable liquid binder. Aqueous dispersions of neoprene and other elastomeric dienes or of an epoxide monomer are cited as examples of suitable binders. Similar formulations are disclosed by several patents to Kiser (Environmental, L.L.C.), U.S. Pat. No. 5,453,313 (Sep. 26, 1995), U.S. Pat. No. 5,525,399 (Jun. 11, 1996), U.S. Pat. No. 5,582,864 (Dec. 10, 1996), and U.S. Pat. No. 5,587,234 (Dec. 24, 1996). The binder in these formulations is an elastomeric polysulfide, which must comprise 50% or more by volume of the formulation. A still further formulation is that of Lanphier, U.S. Pat. No. 5,527,409 (Jun. 18, 1996), which includes a urethane binder and a compaction process to form the comminuted tire particles into a log, from which a sheet is then cut.

The crumb rubber formulations used in the practice of the present invention are commercially available from a number of sources, such as the formulations used in manufacturing rubber mats for home or industrial use.

FIGS. 4A-4F show the steps involved in manufacturing a base 24 for the device of invention by molding a raw crumb rubber compound. As shown in FIG. 4, a mold 59 is provided having a plurality of cavities 61. Each cavity has a bottom surface 63, surrounding sidewalls 65 and an initially open top. Each of the cavities also has an upright steel plug 67 which is welded and approximately centered in each of the respective cavities on the respective bottom surfaces thereof. The plugs are left permanently in place in the mold cavities.

A commercially available raw crumb rubber waste product is supplied to the mold cavities by the dispenser 69. The crumb rubber is supplied as a quantity of crumb rubber “pellets.” Once the mold cavities are filled, a source of pressure is applied to the mold. This can be accomplished, for example, by lowering a hydraulic press 71 over the mold so that the press comes down and compresses the crumb rubber pellets in the cavities 61. This action causes the rubber in the mold cavities to be heated and causes the pellets to stick together to form a mat-like rubber product. Each of the mats (24 in FIG. 4C) is pulled from its respective mold cavity, whereby the upright plug (67 in FIG. 4A) leaves a centrally located hole (73 in FIG. 4c) in each mat.

As shown in FIG. 4D, a suitable adhesive/glue 75 is then typically applied to the inside walls of the hole 73 in the mat and thereafter a PVC receptacle piece (29 in FIG. 4E) is installed within the respective mat holes by pushing the receptacle piece into the hole. The upper end 76 of each of the receptacles pieces is flush with the top surface 24 of the mat. The respective receptacle pieces form the base receptacle for the upright PVC portions of the device, as has previously been described. FIG. 4F shows the completed assembly with the upright member 27 installed within the base receptacle 29.

In use, the pipe supporting devices of the invention are installed beneath the pipe to be supported at spaced intervals along the pipe. The flat bottom portion of the base rests upon the associated support structure, such as a rooftop, to provide stability for the device and ensure the firm engagement of the pipe to be supported. The overall height which is desired is determined and the upright member 27 is altered to the desired dimensions by severing the upright member at the appropriate graduation 53. The upright member is then installed within the receptacles of the respective connector portions 31, 35 and the pipe is received within the recess 39 of the receiving portion 35. These components of the device are typically glued in place with, for example, a suitable commercially available PVC cement where the components are themselves formed of PVC pipe. The pipe can be secured in place with a tie wrap 43 which is passed about the pipe exterior and secured after being passed through the openings (51, 57 in FIG. 2) provided in the receiving portion.

An invention has been provided with several advantages. The pipe supporting device of the invention is simple in design and economical to manufacture. The flat bottomed base of the device, conveniently formed of waste crumb rubber, supports the device in a stable fashion on a surrounding support surface. It is not necessary to glue the bottom surface of the improved base of the device to, for example, a rooftop. If desired, each of the upright and pipe receiving components of the device can be molded or extruded from PVC or other commercially available plastic materials. PVC is generally preferred because it resists deterioration from exposure to ultraviolet light, i.e., sunlight, is fire retardant, and has the requisite strength for most applications. The adjustable upright member of the pipe supporting device allows the overall height of the device to be adjusted for supporting an exposed pipe at any of a number of desired heights on a roof or other surrounding support structure. A series of graduations provides a convenient means for determining the overall length of the upright member. Since the upright member of the device is comprised of commercially available PVC pipe, it can be easily cut or sawed to the desired length. This allows a standard sized pipe supporting device to be mass produced which can be altered in overall height to the requirements of a particular job while on the job site. The device is simple to install and saves time over prior art practices, such as cutting and assembling wooden boards to the required heights.

While the invention has been shown in several of its forms, it is not thus limited but is susceptible to various changes and modifications without departing from the spirit thereof.

What is claimed is:

1. A pipe supporting device adapted to receive and support at least one exposed condensate drain pipe from an air conditioning unit located on a roof, the device comprising:
a base having an upwardly extending receptacle portion;
a first upright member formed of a synthetic plastic material of a first selected length, the first upright member having a first extent which is insert able within the upwardly extending receptacle portion of the base to engage the base receptacle portion;
a saddle shaped receiving portion for receiving and supporting the exposed pipe, the saddle shaped receiving portion being supported about a common juncture having a downwardly extending receptacle portion for receiving an opposite extent of the first upright member and engaging the first upright member;
wherein the first selected length of the first upright member can be altered by u user at a job site to thereby provide a device having a desired overall height for supporting the exposed pipe at a desired height on the roof;
wherein the base is formed of molded crumb rubber waste product, the base having a top surface and a relatively flat bottom surface for resting on the roof, and wherein the upwardly extending receptacle portion which is formed in the top surface of the base comprises a hollow length of synthetic plastic material which is seated within an opening in the top surface and glued in place and which is selectively sized to receive the opposite extent of the first upright member and snugly engaging the upright member.

2. The device of claim 1, wherein the first upright member and the receptacle are both formed of a length of PVC pipe.

3. The pipe supporting device of claim 2, wherein at least the first upright member has graduations provided along the length thereof and wherein the first selected length of the first upright member is altered by severing the length thereof at a selected graduation.

4. The device of claim 3, further comprising:
an engagement member connectable with the saddle shaped receiving portion for engaging and securing a portion of a pipe which is received and supported within the saddle shaped receiving portion, the engagement member comprising a flexible tie wrap and wherein at least one opening is provided in the saddle shaped receiving portion of the device for connecting the tie wrap to the saddle shaped receiving portion.

5. A pipe supporting device adapted to receive and support an exposed pipe, the device comprising:
a base having a top surface and a flat bottom surface for resting on an adjacent support surface, the base having an upwardly extending receptacle portion;
a first upright member formed from a first selected length of hollow PVC pipe, the first upright member having a first extent which is insertable within the upwardly extending receptacle portion of the base to engage the base receptacle portion;
an injection molded, plastic saddle shaped receiving portion for receiving and supporting the exposed pipe, the saddle shaped receiving portion having a concave receiving recess for receiving the pipe and a downwardly extending receptacle portion for receiving an opposite extent of the first upright member and engaging the first upright member;
an engagement member connectable with the saddle shaped receiving portion for engaging and securing a portion of a pipe which is received and supported within the receiving recess of the saddle shaped receiving portion;
wherein the first selected length of the first upright member can be altered by a user at a job site to thereby provide the device having a desired overall height for supporting the exposed pipe at a desired height; and
wherein the base is formed of molded crumb rubber waste product, the base having a top surface and a relatively flat bottom surface for resting on the roof, and wherein the upwardly extending receptacle portion which is formed in the top surface of the base comprises a hollow length of synthetic plastic material which is seated within an opening in the top surface and which is selectively sized to receive the opposite extent of the first upright member and snugly engaging the upright member.

6. A method of supporting an exposed conduit on a surrounding support surface, the method comprising the steps of:
providing a plurality of conduit supporting devices beneath the conduit at spaced intervals along the conduit on the surrounding support surface, each of the conduit supporting devices having a base with a flat bottom for resting on the support surface and which supports additional synthetic plastic components, the base having an upwardly extending receptacle portion having a generally cylindrical upper opening;
installing a first extent of an upright member within the cylindrical upper opening of the upwardly extending receptacle portion of the base, the upright member having a central bore;
fitting a saddle shaped receiving portion onto an opposite extern of the upright member, the saddle shaped receiving portion having a downwardly extending receptacle portion for receiving the opposite extent of the upright member;
whereby the plurality of conduit supporting devices support the conduit on the surrounding support surface; and
wherein the base is formed of molded crumb rubber waste product, the base having a top surface and a relatively flat bottom surface for resting on the roof, and wherein the upwardly extending receptacle portion which is formed in the top surface of the base comprises a hollow length of synthetic plastic material which is seated within an opening in the top surface and which is selectively sized to receive the opposite extent of the first upright member and snugly engaging the upright member.

7. The method of claim 6, further comprising the steps of altering the length of the upright member at other of the spaced intervals along the exposed conduit, to thereby provide a device having a desired overall height for supporting the exposed conduit at a desired degree of slope on the adjacent support surface.

8. The method of claim 7, wherein the length of the upright member is altered by severing the length thereof to an approximate desired height of the conduit supporting device and wherein a final desired height of the conduit supporting device is obtained by adjusting the length of the extent residing within either or both receptacle portions, the upright being glued at the final desired height.

9. The method of claim 8, wherein the synthetic plastic components are selected from the group consisting of polyvinylchloride and acrylonitrile styrene acrylate plastics.

10. The method of claim 9, an engagement member is connected with the saddle shaped receiving portion for engaging and securing a portion of a pipe which is received and supported within the receiving recess of the saddle shaped receiving portion, and wherein the engagement element is a flexible tie wrap and wherein at least one opening is provided in the saddle shaped receiving portion of the device for connecting the tie wrap.

11. The method of claim 6, wherein the crumb rubber base is manufactured by the following steps:
supplying a given quantity of waste crumb rubber in the form of raw crumb rubber pellets and pouring a given quantity of the pellets into a mold, the mold being divided into a plurality of cavities, each having a bottom surface, surrounding sidewalls and an initially open top, each of the cavities also having an upright plug approximately centered in the cavity on the bottom surfaces thereof;
filling the mold cavities with the raw crumb rubber pellets;
applying pressure to the mold from above so that the crumb rubber pellets in the cavities are compressed, which action causes the rubber pellets to be heated, thereby causing the pellets to fuse together to form a mat-like rubber product;
pulling each mat out of the mold, whereby the upright plug leaves a centrally located hole in each mat;
installing a PVC receptacle piece within the respective mat holes by pushing the receptacle piece into the holes, the respective receptacle pieces forming the base receptacle for the upright PVC portions of the device.

12. The method of claim 11, wherein the PVC receptacles are secured within the respective mat holes by gluing them in place.

13. The method of claim 11, wherein the pressure applied to the raw crumb rubber pellets in the mold cavities is applied by lowering a hydraulic press onto the filled mold cavities.
